(19) United States
(12) Patent Application Publication
(10) Pub. No.: US 2008/0138759 A1
(43) Pub. Date: Jun. 12, 2008

(54) EYELET FOR COIL SPRING AND METHODS ASSOCIATED THEREWITH

(76) Inventors: Neal D. Kravitz, Fairfax Station, VA (US); David Wolf, Lakewood, CO (US); Leon W. Laub, Fort Collins, CO (US)

Correspondence Address: SHERIDAN ROSS PC, 1560 BROADWAY, SUITE 1200, DENVER, CO, 80202, US

(21) Appl. No.: 11/858,076

(22) Filed: Sep. 19, 2007

Related U.S. Application Data
(60) Provisional application No. 60/826,207, filed on Sep. 19, 2006.

(51) Int. Cl. A61C 7/00

(52) U.S. Cl. 433/21; 433/18; 433/24

(57) ABSTRACT

An orthodontic appliance for orthodontic treatment includes first and second eyelets connected to coil spring at each end of the coil spring, thereby forming a double eyelet and spring unit. In one embodiment, a connector for detachably attaching a spring to an orthodontic appliance includes a means for engaging an appliance. In one embodiment the connector is an eyelet having an aperture in its central region for allowing the spring to be detachably attached to the orthodontic appliance. The aperture may have a variety of shapes. Alternatively, the connector may comprise a hook or equivalent structure for facilitating the spring to be attached to the orthodontic appliance.

### CROSS REFERENCE TO RELATED APPLICATION

This application claims priority to U.S. Provisional Patent Application Ser. No. 60/826,207, filed Sep. 19, 2006. The entire content of this application is considered to be part of the disclosure of the present application, and is hereby incorporated by reference as if fully set forth herein.

### FIELD OF THE INVENTION

The present invention relates to orthodontic appliances, and more particularly, to a device configured for interconnecting a biasing member, such as a spring, to another orthodontic appliance.

### BACKGROUND

There is further need for a device and/or assembly that allows a treating orthodontist to provide a tensile force between two locations within the mouth of a patient. There is also the need for methods that provide more options for treating misaligned teeth and/or malocclusions.

### SUMMARY

An orthodontic appliance is provided that includes at least a first eyelet operatively associated with an end of a biasing member, the eyelet comprising a means for detachably attaching the eyelet to another orthodontic appliance.

Various embodiments of the present invention are set forth in the attached figures and in the detailed description of the invention as provided herein and as embodied by the claims. It should be understood, however, that this Summary does not contain all of the aspects and embodiments of the present invention, is not meant to be limiting or restrictive in any manner, and that the invention as disclosed herein is and will be understood by those of ordinary skill in the art to encompass obvious improvements and modifications thereto.

Additional advantages of the present invention will become readily apparent from the following discussion, particularly when taken together with the accompanying drawings.

### BRIEF DESCRIPTION OF THE DRAWINGS

FIGS. 1 and 2 are perspective views of a device in accordance with an embodiment of the present invention;

FIG. 3A is a side elevation view of the device shown in FIGS. 1 and 2;

FIG. 3B is a partial perspective view of a portion of the device of FIG. 1 being placed over a projection of an orthodontic appliance;

FIGS. 4 and 5 are perspective views of a device in accordance with another embodiment of the present invention;

FIG. 6 is a side elevation view of the device shown in FIGS. 4 and 5;

FIG. 7 is an end-on elevation view of the device shown in FIGS. 4-6;

FIG. 8 is a side elevation view of another embodiment of the present invention;

FIG. 9 is a side elevation view of an embodiment of the present invention;

FIG. 10 is a perspective view of the device shown in FIG. 9;

FIG. 11 is a side elevation view of an eyelet shown in FIG. 9;

FIG. 12 is a perspective view of the device shown in FIG. 11; and

FIG. 13 is a perspective view of a use of an embodiment of the present invention, wherein the device is used in orthodontic treatment to close a space.

The drawings are not necessarily to scale.

### DETAILED DESCRIPTION

The present invention comprises a device adapted for interconnecting a biasing member to another orthodontic appliance. In an exemplary embodiment, the biasing member comprises a spring, such as a coil spring. The eyelet of the present invention allows the treating physician, dentist, orthodontist, and/or dental clinician or staff member many more options when treating malocclusions. The embodiments shown in the drawings and/or described herein may be encompass more than one invention.

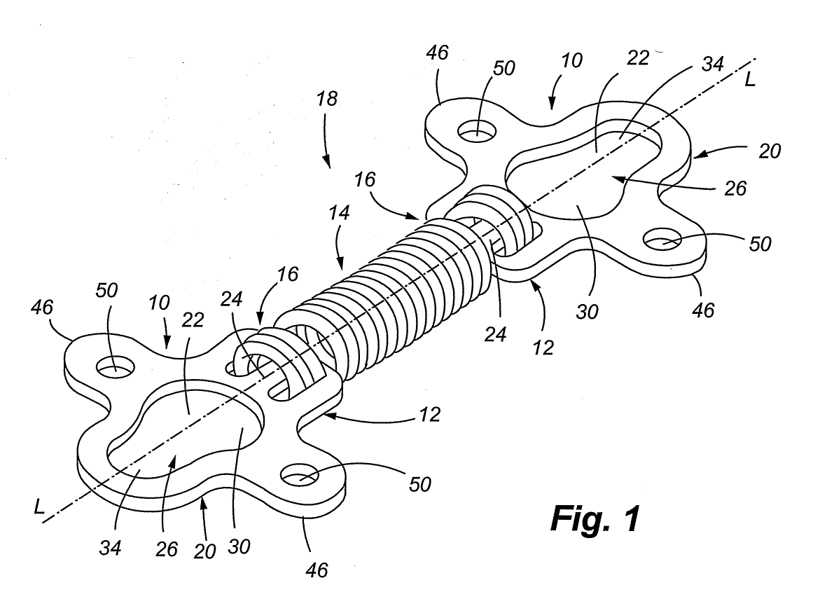

Referring now to FIGS. 1-3A, a device in accordance with a first embodiment of the present invention is shown. The device comprises an eyelet 10 for interconnecting an open or closed coil spring 14 to another orthodontic appliance. The eyelet 10 and coil spring 14 may comprise two pieces that are connected, or alternatively, they may be integrally formed. As shown in FIGS. 1-3A, first and second eyelets 10 are connected to coil spring 14 at each end of the coil spring 14, thereby forming a double eyelet and spring unit 18. Again, the two eyelets 10 and spring 14 may comprise a plurality of pieces, or they may be integrally formed as one piece.

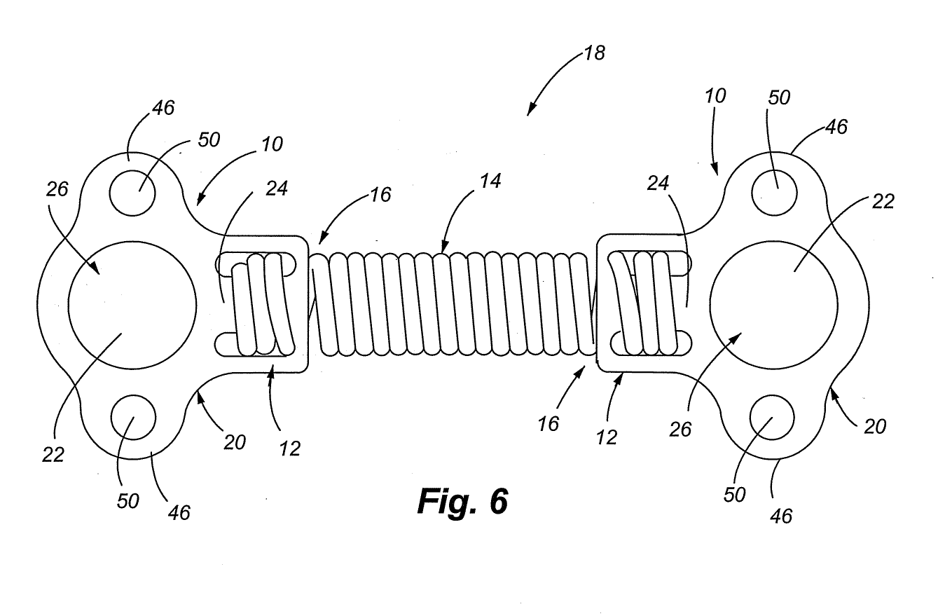

As best seen in FIG. 8 and described in more detail below, embodiments of the present invention also include a single eyelet and spring unit 54, wherein one eyelet 10 is operatively associated with a spring 14, and the spring is in turn operatively associated with another orthodontic appliance that does not comprise a second eyelet 10.

In accordance with embodiments of the present invention, the eyelet may comprise a forked region 12 for receiving an end 16 of the coil spring 14 for those configurations where the coil spring 14 is a separate device from the eyelet 10. In one embodiment, the forked region 12 comprises a central bar 24 around which one or more windings of the coil spring 14 are placed.

Referring again to FIGS. 1-3A, and in accordance with embodiments of the present invention, the eyelet 10 can include one or more openings or apertures having a variety of possible shapes. By way of example and not limitation, the one or more apertures may have a square, rectangular, circular, oval, rhomboidal, triangular, trapezoidal, oblong, or irregular shape.

For the embodiment depicted in FIGS. 1-3A, the eyelet 10 includes a body 20 having an opening or aperture 22 within substantially the central region 26 of the eyelet 10. In at least one embodiment, the aperture 22 of eyelet 10 may be described as having a pear shape, where a first region 30 of the aperture 22 is larger than a second region 34 of the aperture 22. In general, the aperture 22 is used to engage a second device, such as, by way of example and not limitation, to engage the eyelet 10 directly onto an invasive device, such as an implant or mini-implant. The implant can contain a button, bracket, hole, lobe or any other shape in order to attach other appliances. For example, a temporary anchorage device (TAD) may be used, wherein the TAD includes a head that is shaped like a button for receiving the eyelet 10. The aperture 22 can alternatively be used to engage auxiliary appliances, elastic ligatures, ligature wire, arch wires or any combination of the foregoing.

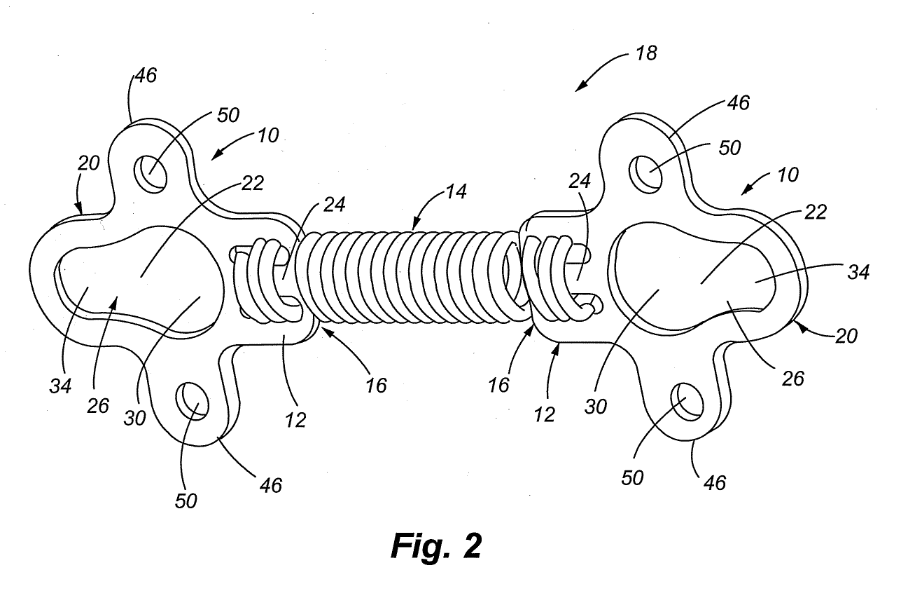

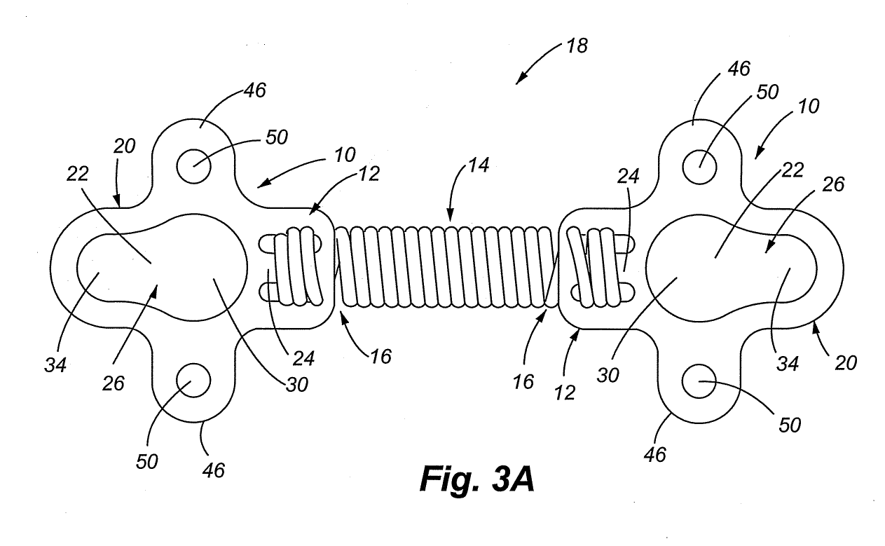

Methods of using the double eyelet and spring unit 18 include attaching a first eyelet 10 to a first orthodontic appliance, such as a TAD, and then attaching the second eyelet 10 to a second orthodontic appliance, such as a hook associated with a bracket or another TAD, wherein the coil spring 14 provides a tensile force between the two appliances. Referring to FIG. 3B, in use, the first region 30 of the aperture 22 is positioned over a projection 38 associated with an orthodontic appliance, and then the aperture is slid into position to engage the projection 38 within the second region 34 of the eyelet 10. Since the coil spring 14 is under tension when fully installed, the second region 34 is prevented from accidentally slipping off of the projection 38 because the projection preferably includes an enlarged head 42 for enabling placement within the first region 30, but preventing unwanted extraction from the second region 34. As tension is applied by attaching the other end of the coil spring 14 to another orthodontic appliance, the projection 38 is maintain at the distal end of the aperture 22; that is, generally within the second region 34 of the aperture 22.

In accordance with embodiments of the present invention, each eyelet 10 may also include one or more ears or lobes 46 that extend outward relative to a longitudinal axis L-L of the eyelet 10. The lobes 46 extend outward from the body 20 of the eyelet 10 and provide a structure to facilitate ease of placement by the treating physician, dentist, orthodontist, and/or dental clinician or staff member, because the lobes 46 allow the eyelet 10 to be more carefully, accurately, and quickly placed in the patient's mouth by using an orthodontic instrument, such as pliers or tweezers. More particularly, the lobes 46 provide more material to grip with a placement instrument, where the lobes 46 preferably provide a gripping region adjacent to, but separated from the aperture 22. The lobes 46 may vary in thickness for providing appropriate strength characteristics for grasping and placement by the placement instrument. That is, the lobes 46 can be used to hold the coil spring while it is being attached to another orthodontic appliance. In accordance with embodiments of the present invention, the one or more lobes 46 may comprise lobe apertures 50 that can be used to engage auxiliary appliances, elastic ligatures, ligature wire, arch wires or any combination of the foregoing. In one or more embodiments of the present invention, the lobe apertures 50 can be used to ligate two coil springs together. Alternatively, as shown in FIG. 3B and FIGS. 9-13, one or more of the lobes 46 may not include lobe apertures 50. That is, the lobes 46 may be solid and and/or otherwise comprise texturing or grooves, but one or more of the lobes 46 on an eyelet 10 may be solid and not necessarily include an opening that penetrates from the front to the back of the eyelet 10.

In accordance with embodiments of the present invention, the eyelet 10 can be semi-permanently secured to an orthodontic appliance with a hairline separation or hinged opening (including, for example, a pin type of hinged mechanism or a living hinge type of mechanism) in the eyelet 10. More particularly, in at least one embodiment the eyelet 10 is configured with structure similar to a carabineer that allows the eyelet 10 to be connected to a post, screw or other feature of an orthodontic appliance. This alternate structure also provides the treating physician, dentist, orthodontist, and/or dental clinician an option for structure available for attaching a coil spring to an orthodontic appliance, wherein such structure ensures that the connector or eyelet 10 will not become detached during treatment.

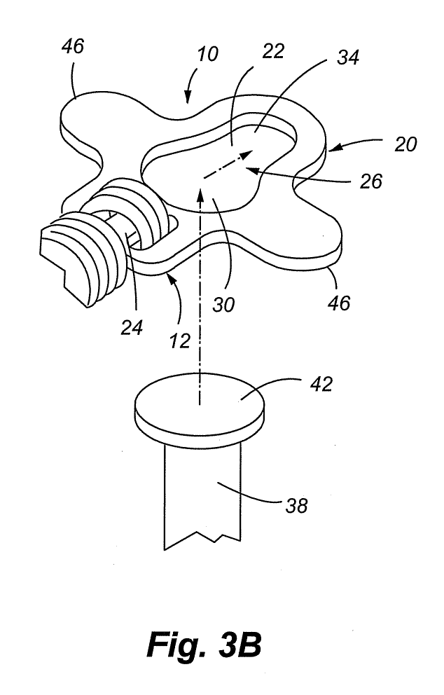

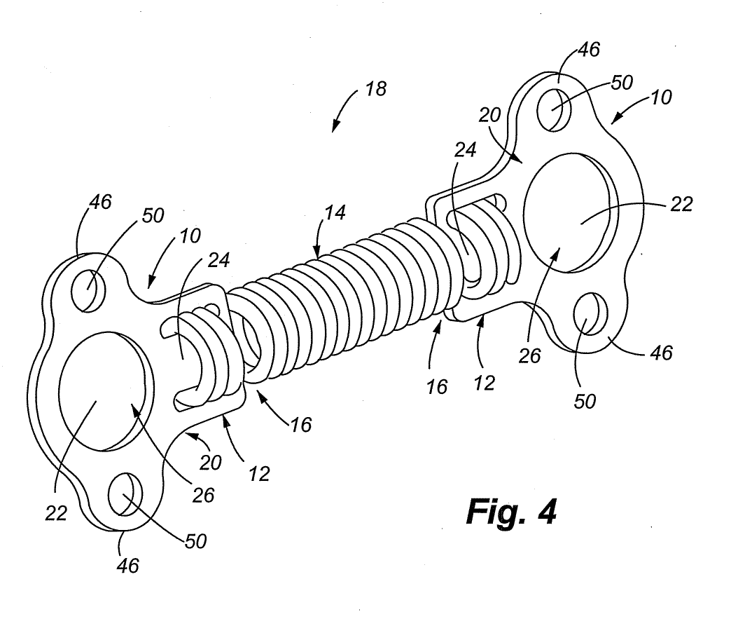

Referring now to FIGS. 4-6, a second embodiment of the present invention is shown. The aperture 22 of eyelet 10 of FIGS. 4-6 is substantially circular in shape. Thus, the eyelet may be modified and such modifications are within the scope of the present invention.

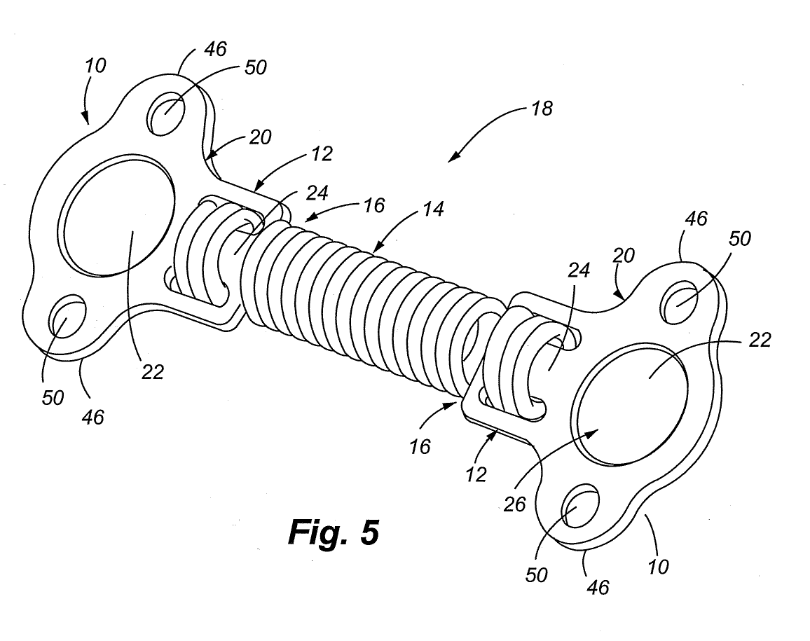

FIG. 7 provides an end-on elevation view of an eyelet 10 and coil spring combination. The lobes 46 can be seen extending beyond the main portion of the body 20 of eyelet 10.

Referring now to FIG. 8, a single eyelet and spring unit 54 is shown that includes an eyelet 10 operatively associated with coil spring 14 at a first end 58 of the coil spring 14. The second end 62 of the coil spring 14 comprises a bent winding 66 of the coil spring 14. Of course, as those skilled in the art will appreciate, the second end 62 of the coil spring 14 may include some other alternative structure.

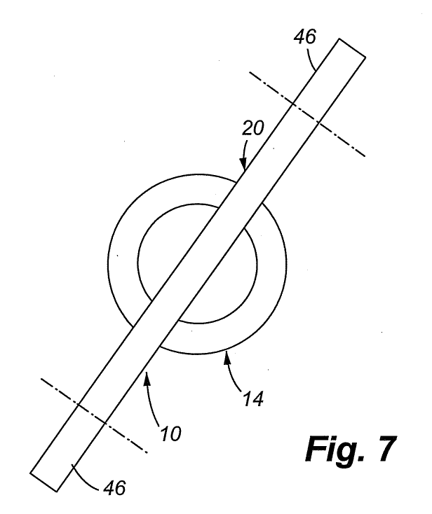

Referring now to FIGS. 9-11, a double eyelet and spring unit 18 is shown that includes a first eyelet 10 having an aperture 22 with a first region 30 of the aperture 22 larger than a second region 34 of the aperture 22. The second eyelet 10 comprises an aperture 22 that is substantially circular in shape with a substantially uniform diameter. In use, the second eyelet is used to engage a first appliance, such as a hook associated with a bracket or archwire, and then the first eyelet 10 is positioned to slip over and slidably engage a second appliance, such as a TAD.

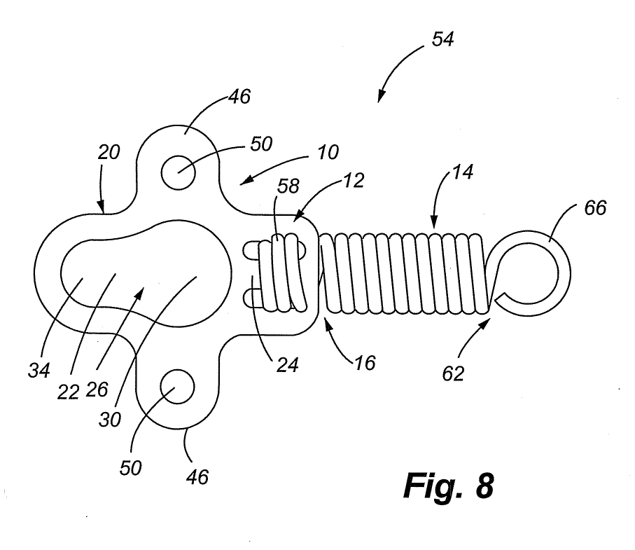

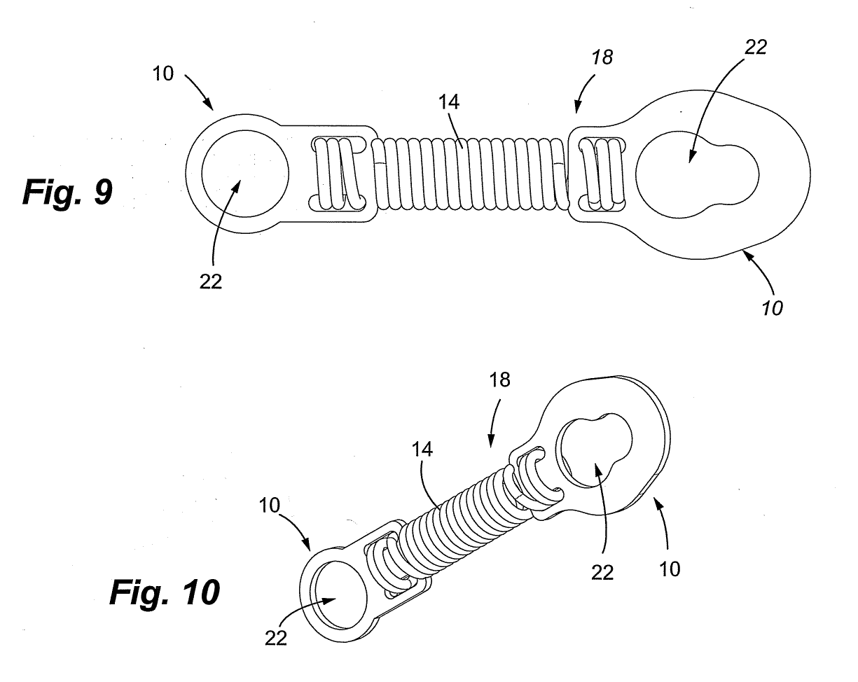

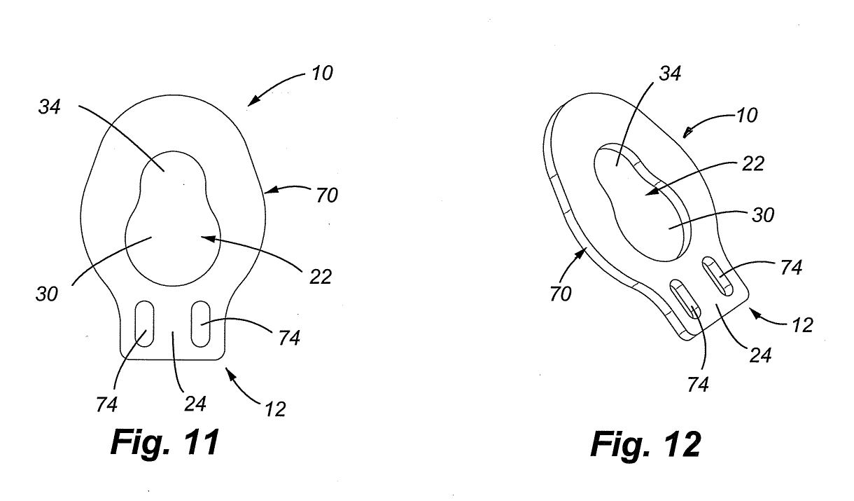

Referring now to FIGS. 11 and 12, detail drawings of the first eyelet shown in FIGS. 9 and 10 is illustrated. The eyelet 10 of FIGS. 11 and 12 features a gradually curving perimeter that 70 that limits the possibility of tissue being pinched when sliding the aperture 22 over a projection 38 associated with an appliance, such as a TAD.

In accordance with embodiments of the present invention, the body 20 of each eyelet 10 preferably contains rounded edges between the webbing for maximum strength and patient comfort. In addition, the eyelets 10 may comprise one or more clips for self-ligating purposes, or as a cap that ensures a strong bond between the implant and spring.

The present invention has a variety of uses and applications. By way of example and not limitation, the double eyelet and spring unit 18 or single eyelet and spring unit 54 can be connected from bracket to bracket, bracket to implant, implant to implant, auxiliary to implant, auxiliary to auxiliary, bracket to auxiliary or any combination of the foregoing.

In accordance with at least one embodiment of the present invention, the eyelet 10 can be configured to screw clockwise or counter-clockwise to lengthen or shorten the length of the spring 14. As shown in FIGS. 11 and 12, the eyelet 10 may feature receptacles 74 for receiving the coil spring 14, wherein, in at least one embodiment, the receptacles 74 are sized to receive multiple windings of the spring 14. This can help generate a continuous and/or sufficiently strong force without changing springs 14, and over an interval of treatment, the treating dentist, orthodontist or dental clinician can easily rotate the spring 14 to increase or decrease the windings of the spring 14 that are received within the receptacles 74, thereby altering the tensile force applied by the spring 14. Alternatively, the eyelet 10 may be interconnected to a biasing member without using receptacles 74, and such variations are within the scope of the present invention.

The eyelet 10 preferably is made of a material that is suitable for placement into a patient's mouth. By way of example and not limitation, the eyelet 10 and structures that may be associated with the eyelet may be made of stainless steel, or a noble or precious metal alloy liner. Such materials can be stamped, acid etched, or cut with a high-pressure water jet. Other materials known to those skilled in the art are also considered encompassed by the present invention, and the foregoing discussion is meant to provide examples of a suitable material, and is not meant to be an all inclusive listing of suitable materials.

One will appreciate that the eyelet shown in the figures is attachable to, for example, a TAD, such as a screw including an exposed button (or other suitable fixation device) that is screwed into the upper or lower jaw bone during treatment, and then later preferably removed. Note, all Figures, other than FIGS. 3B and 9-13, show a small hole in each lobe (e.g. protrusion). Thus, embodiments that are devoid of apertures or holes should be understood as being encompassed by the present invention. One will also note that it is preferable to provide a device with certain configurations that assist in reducing impingement with other tissues or structures. For example, using a slimmer profile in design (e.g., where a lobe is smaller and not as pronounced), the treating dentist or orthodontist is able to reduce or eliminate any tissue impingement of the eyelet 10 in the mouth, enhancing the comfort to the patient. Such configurations, however, should preferably retain sufficient dimensions, such as along the width thereof, so that it can be held by an orthodontic instrument (e.g., pliers). As noted above, holding the eyelet 10 with an instrument makes it easier for the treating dentist, orthodontist or dental clinician to stretch the coil spring 14 and hook the eyelet around the TAD or hook. The spade (or clover shaped) eyelet can be on either one end only of the eyelet, or both ends. If it is on only one end, the other eyelet is preferably of a round shape.

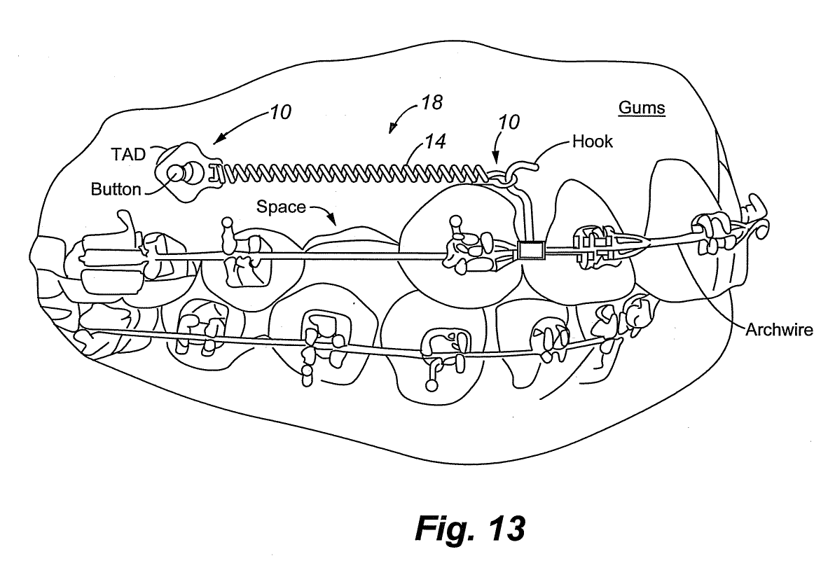

FIG. 13 demonstrates an illustration of an eyelet coil spring in accordance with the present invention, showing how, in clinical usage, it is adapted to close particular spaces. That is, one or more embodiments of the present invention are adapted for use as a space-closing device. As shown in FIG. 13, a double eyelet and spring unit 18 includes an eyelet 10 engaging a crimpable hook that is attached to an archwire, while the second end comprises an eyelet 10 engaging a mini-implant or TAD.

In addition to methods that may be described above, one or more embodiments of the one or more inventions described herein include a method of using an orthodontic assembly for closing a space between two or more teeth in the mouth of a patient. The method includes implanting an implant device into a portion of the bone of the mouth of the patient. The implant device preferably includes an exposed portion that extends exterior of the gum tissue residing over the bone. The method further includes attaching a biasing member to the exposed portion of the implant device, the biasing member including a first eyelet for engaging the exposed portion of the implant device, the biasing member also including a second eyelet. In addition, the method includes engaging the second eyelet to an orthodontic appliance operatively associated with one or more of the teeth, the orthodontic appliance adapted for receiving the second eyelet. A tensile force is, therefore, applied to the biasing member by engaging the first eyelet to the exposed portion of the implant device and engaging the second eyelet to the orthodontic appliance, and wherein the space is at least partially closed by application of the tensile force.

Other methods include attaching a first eyelet connected to a coil spring to a first orthodontic appliance, and then attaching a second eyelet connected to the coil spring to a second orthodontic appliance, wherein any of the eyelets and/or biasing members and/or coil springs and/or assemblies described herein are applicable for use in the method.

Though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter. Moreover, various other aspects of the invention disclosed herein are set out in the following numbered clauses:
1. An orthodontic appliance, comprising:
   first and second eyelets operatively associated with a coil spring.
2. The orthodontic appliance of Clause 1, wherein at least one of the first and second eyelets comprises an aperture adapted to be attached to another orthodontic appliance.
3. The orthodontic appliance of Clause 2, wherein the aperture is oblong in shape.
4. The orthodontic appliance of Clause 3, wherein the oblong shape includes a first region having larger cross-sectional area than a second region, wherein the first region is located a first distance from the coil spring, wherein the second region is located a second distance from the coil spring, and wherein the first distance is less than the second distance.
5. The orthodontic appliance of Clause 1, wherein at least one of the first and second eyelets comprises at least a first lobe, the first lobe adapted for being held by a placement tool.
6. The orthodontic appliance of Clause 5, wherein the first lobe comprises an aperture.
7. An orthodontic appliance, comprising:
   first and second connectors operatively associated with a coil spring, the first and second connectors comprising a means for detachably attaching the connectors to another orthodontic appliance.
8. The orthodontic appliance of Clause 7, wherein the means for detachably attaching comprises an aperture.
9. The orthodontic appliance of Clause 8, wherein the aperture is located within a central region of the connector.
10. The orthodontic appliance of Clause 9, wherein the aperture is oblong in shape, wherein the oblong shape includes a first region having larger cross-sectional area than a second region, wherein the first region is located a first distance from the coil spring, wherein the second region is located a second distance from the coil spring, and wherein the first distance is less than the second distance.
11. The orthodontic appliance of Clause 7, wherein the means for detachably attaching comprises a hook.
12. An orthodontic appliance, comprising:
   at least a first eyelet operatively associated with an end of a coil spring, the eyelet comprising a means for detachably attaching the eyelet to another orthodontic appliance.
13. The orthodontic appliance of Clause 12, wherein the means for detachably attaching comprises an aperture.
14. The orthodontic appliance of Clause 13, wherein the aperture is oblong in shape.
15. The orthodontic appliance of Clause 13, wherein the aperture is oblong in shape, wherein the oblong shape includes a first region having larger cross-sectional area than a second region, wherein the first region is located a first distance from the coil spring, wherein the second region is located a second distance from the coil spring, and wherein the first distance is less than the second distance.
16. The orthodontic appliance of Clause 12, wherein the means for detachably attaching comprises a hook.
17. A first orthodontic appliance for use with tensioning a second orthodontic appliance with a third orthodontic appliance, the first orthodontic appliance comprising:
   a coil spring having first and second ends; and
   first and second eyelets each comprising a forked region having a center bar bounded laterally by first and second apertures, the first end of the coil spring operatively associated with the forked region of said first eyelet and the second end of the coil spring operatively associated with the forked region of said second eyelet, at least one winding of the first and second ends of the coil spring encircling the central bar and passing through the first and second apertures of the forked region of the first and second eyelets, respectively, the first and second eyelets further comprising a central region having an opening adapted for operatively engaging the second and third orthodontic appliances, respectively, wherein the opening comprises at least two regions, wherein a first region is larger than a second region, and wherein the first region is located closer to the forked region than the second region, the first and second eyelets comprising first and second lobes, wherein the first lobe is located on a first side of the eyelet and the second lobe is located on a second side of the eyelet, and wherein the lobes are adapted for gripping by a placement instrument;
   wherein a tensile force is applied between the second and third orthodontic appliances by attaching the first eyelet of the first orthodontic appliance to the second orthodontic appliance and attaching the second eyelet of the first orthodontic appliance to the third orthodontic appliance.
18. The first orthodontic appliance of Clause 17, wherein at least one of the first and second lobes each comprise an appliance receiving aperture.
19. The first orthodontic appliance of Clause 17, wherein at least one of the first and second lobes do not comprise an aperture.
20. A first orthodontic appliance for use with tensioning a second orthodontic appliance with a third orthodontic appliance, the first orthodontic appliance comprising:
   a coil spring having first and second ends; and
   an eyelet comprising a forked region having a center bar bounded laterally by first and second apertures, the first end of the coil spring operatively associated with the forked region of said eyelet, at least one winding of the first end of the coil spring encircling the central bar and passing through the first and second apertures of the forked region of the eyelet, the eyelet further comprising a central region having an opening adapted for operatively engaging the second orthodontic appliance, wherein the opening comprises at least two regions, wherein a first region is larger than a second region, and wherein the first region is located closer to the forked region than the second region, the eyelet comprising first and second lobes, wherein the first lobe is located on a first side of the eyelet and the second lobe is located on a second side of the eyelet, and wherein the lobes are adapted for gripping by a placement instrument;
   wherein a tensile force is applied between the second and third orthodontic appliances by attaching the eyelet of the first orthodontic appliance to the second orthodontic appliance and attaching the second end of the coil spring to the third orthodontic appliance.
21. The first orthodontic appliance of Clause 20, wherein at least one of the first and second lobes each comprise an appliance receiving aperture.
22. The first orthodontic appliance of Clause 20, wherein at least one of the first and second lobes do not comprise an aperture.
23. An orthodontic assembly for closing a space between two or more teeth in the mouth of a patient, the teeth extending into a bone of the mouth, wherein a gum tissue covers the bone, the assembly comprising:
   an implant device extending into a portion of the bone, the implant device including an exposed portion that extends exterior of the gum tissue;
   a biasing member including a first eyelet for engaging the exposed portion of the implant device, the biasing member including a second eyelet;
   an orthodontic appliance operatively associated with one or more of the teeth, the orthodontic appliance adapted for receiving the second eyelet;
   wherein a tensile force is applied to the biasing member by engaging the first eyelet to the exposed portion of the implant device and engaging the second eyelet to the orthodontic appliance, and wherein the space is at least partially closed by application of the tensile force.
24. The orthodontic assembly of Clause 23, wherein the orthodontic appliance comprises a hook.
25. The orthodontic assembly of Clause 23, wherein the orthodontic appliance comprises structure interconnected to a bracket.
26. The orthodontic assembly of Clause 23, wherein the biasing member comprises a coil spring.
27. The orthodontic assembly of Clause 26, wherein at least one of the first and second eyelets comprises a forked region having a center bar bounded laterally by first and second apertures, the first end of the coil spring operatively associated with the forked region of said at least one of the first and second eyelets, at least one winding of the first end of the coil spring encircling the central bar and passing through the first and second apertures of the forked region of the said at least one of the first and second eyelets.
28. The orthodontic assembly of Clause 27, wherein said at least one of the first and second eyelets further comprises a central region having an opening adapted for operatively engaging the exposed portion of the implant, wherein the opening comprises at least two regions, wherein a first region is larger than a second region, and wherein the first region is located closer to the forked region than the second region.
29. The orthodontic assembly of Clause 28, wherein said at least one of the first and second eyelets further comprises first and second lobes, wherein the first lobe is located on a first side of the eyelet and the second lobe is located on a second side of the eyelet, and wherein the lobes are adapted for gripping by a placement instrument.
30. A method of using an orthodontic assembly for closing a space between two or more teeth in the mouth of a patient, the teeth extending into a bone of the mouth, wherein a gum tissue covers the bone, the method comprising:
   implanting an implant device into a portion of the bone, the implant device including an exposed portion that extends exterior of the gum tissue;
   attaching a biasing member to the exposed portion of the implant device, the biasing member including a first eyelet for engaging the exposed portion of the implant device, the biasing member including a second eyelet;
   engaging the second eyelet to an orthodontic appliance operatively associated with one or more of the teeth, the orthodontic appliance adapted for receiving the second eyelet;
   wherein a tensile force is applied to the biasing member by engaging the first eyelet to the exposed portion of the implant device and engaging the second eyelet to the orthodontic appliance, and wherein the space is at least partially closed by application of the tensile force.
31. The method of Clause 30, wherein prior to said engaging, the orthodontic appliance is installed, the orthodontic appliance including a hook operatively associated with at least one of an archwire and an orthodontic bracket.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and\or reducing cost of implementation.

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

In one embodiment, the present invention is directed to the closing of a space using a spring (preferably coil spring) that employs an eyelet design (preferably shaped in a clover or spade configuration or geometry) on one or both ends. In other embodiments, one end may be round and the other some other shape (e.g. clover or spade shaped). A particularly shaped eyelet, for example a spade eyelet, may be hooked over a mini-implant so as to serve as an anchorage point for a coil spring or another appliance. A round eyelet can be provided to fit over a crimpable hood, which is itself connected or operatively associated with an archwire. One of skill in the art will appreciate the various different applications of the present invention with respect to the variety of appliances, wires, brackets, etc. encountered in the field, all of which are intended to be included herein.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. An orthodontic appliance, comprising:
first and second eyelets operatively associated with a coil spring.

2. The orthodontic appliance of claim 1, wherein at least one of the first and second eyelets comprises an aperture adapted to be attached to another orthodontic appliance.

3. The orthodontic appliance of claim 2, wherein the aperture is oblong in shape.

4. The orthodontic appliance of claim 3, wherein the oblong shape includes a first region having larger cross-sectional area than a second region, wherein the first region is located a first distance from the coil spring, wherein the second region is located a second distance from the coil spring, and wherein the first distance is less than the second distance.

5. The orthodontic appliance of claim 1, wherein at least one of the first and second eyelets comprises at least a first lobe, the first lobe adapted for being held by a placement tool.

6. The orthodontic appliance of claim 5, wherein the first lobe comprises an aperture.

7. An orthodontic appliance, comprising:
at least a first eyelet operatively associated with an end of a coil spring, the eyelet comprising a means for detachably attaching the eyelet to another orthodontic appliance.

8. The orthodontic appliance of claim 7, wherein the means for detachably attaching comprises an aperture.

9. The orthodontic appliance of claim 8, wherein the aperture is oblong in shape.

10. The orthodontic appliance of claim 8, wherein the aperture is oblong in shape, wherein the oblong shape includes a first region having larger cross-sectional area than a second region, wherein the first region is located a first distance from the coil spring, wherein the second region is located a second distance from the coil spring, and wherein the first distance is less than the second distance.

11. The orthodontic appliance of claim 7, wherein the means for detachably attaching comprises a hook.

12. A first orthodontic appliance for use with tensioning a second orthodontic appliance with a third orthodontic appliance, the first orthodontic appliance comprising:
a coil spring having first and second ends; and
first and second eyelets each comprising a forked region having a center bar bounded laterally by first and second apertures, the first end of the coil spring operatively associated with the forked region of said first eyelet and the second end of the coil spring operatively associated with the forked region of said second eyelet, at least one winding of the first and second ends of the coil spring encircling the central bar and passing through the first and second apertures of the forked region of the first and second eyelets, respectively, the first and second eyelets further comprising a central region having an opening adapted for operatively engaging the second and third orthodontic appliances, respectively, wherein the opening comprises at least two regions, wherein a first region is larger than a second region, and wherein the first region is located closer to the forked region than the second region, the first and second eyelets comprising first and second lobes, wherein the first lobe is located on a first side of the eyelet and the second lobe is located on a second side of the eyelet, and wherein the lobes are adapted for gripping by a placement instrument;
wherein a tensile force is applied between the second and third orthodontic appliances by attaching the first eyelet of the first orthodontic appliance to the second orthodontic appliance and attaching the second eyelet of the first orthodontic appliance to the third orthodontic appliance.

13. The orthodontic appliance of claim 12, wherein at least one of the first and second lobes each comprise an appliance receiving aperture.

14. The orthodontic appliance of claim 12, wherein at least one of the first and second lobes do not comprise an aperture.

15. An orthodontic assembly for closing a space between two or more teeth in the mouth of a patient, the teeth extending into a bone of the mouth, wherein a gum tissue covers the bone, the assembly comprising:
an implant device extending into a portion of the bone, the implant device including an exposed portion that extends exterior of the gum tissue;
a biasing member including a first eyelet for engaging the exposed portion of the implant device, the biasing member including a second eyelet;
an orthodontic appliance operatively associated with one or more of the teeth, the orthodontic appliance adapted for receiving the second eyelet;
wherein a tensile force is applied to the biasing member by engaging the first eyelet to the exposed portion of the implant device and engaging the second eyelet to the orthodontic appliance, and wherein the space is at least partially closed by application of the tensile force.

16. The orthodontic assembly of claim 15, wherein the orthodontic appliance comprises a hook.

17. The orthodontic assembly of claim 15, wherein the orthodontic appliance comprises structure interconnected to a bracket.

18. The orthodontic assembly of claim 15, wherein the biasing member comprises a coil spring.

19. The orthodontic assembly of claim 18, wherein at least one of the first and second eyelets comprises a forked region having a center bar bounded laterally by first and second apertures, the first end of the coil spring operatively associated with the forked region of said at least one of the first and second eyelets, at least one winding of the first end of the coil spring encircling the central bar and passing through the first and second apertures of the forked region of the said at least one of the first and second eyelets.

20. The orthodontic assembly of claim 19, wherein said at least one of the first and second eyelets further comprises a central region having an opening adapted for operatively engaging the exposed portion of the implant, wherein the opening comprises at least two regions, wherein a first region is larger than a second region, and wherein the first region is located closer to the forked region than the second region.

21. The orthodontic assembly of claim 20, wherein said at least one of the first and second eyelets further comprises first and second lobes, wherein the first lobe is located on a first side of the eyelet and the second lobe is located on a second side of the eyelet, and wherein the lobes are adapted for gripping by a placement instrument.

22. A method of using an orthodontic assembly for closing a space between two or more teeth in the mouth of a patient, the teeth extending into a bone of the mouth, wherein a gum tissue covers the bone, the method comprising:
implanting an implant device into a portion of the bone, the implant device including an exposed portion that extends exterior of the gum tissue;
attaching a biasing member to the exposed portion of the implant device, the biasing member including a first eyelet for engaging the exposed portion of the implant device, the biasing member including a second eyelet;
engaging the second eyelet to an orthodontic appliance operatively associated with one or more of the teeth, the orthodontic appliance adapted for receiving the second eyelet;
wherein a tensile force is applied to the biasing member by engaging the first eyelet to the exposed portion of the implant device and engaging the second eyelet to the orthodontic appliance, and wherein the space is at least partially closed by application of the tensile force.

23. The method of claim 22, wherein prior to said engaging, the orthodontic appliance is installed, the orthodontic appliance including a hook operatively associated with at least one of an archwire and an orthodontic bracket.
